(19) United States
(12) Patent Application Publication
(10) Pub. No.: US 2015/0252616 A1
(43) Pub. Date: Sep. 10, 2015

(54) QUICK CONNECT MOUNTING SYSTEM AND TREE MOUNTED HUNTING STANDS

(71) Applicants: Leigh Collyer, Bemidji, MN (US); Corey Strege, Saint Michael, MN (US); Donald Strege, Bemedji, MN (US)

(72) Inventors: Leigh Collyer, Bemidji, MN (US); Corey Strege, Saint Michael, MN (US); Donald Strege, Bemedji, MN (US)

(21) Appl. No.: 14/562,878

(22) Filed: Dec. 8, 2014

Related U.S. Application Data
(60) Provisional application No. 61/948,632, filed on Mar. 6, 2014.

(51) Int. Cl. E06C 1/34; A01M 31/02

(52) U.S. Cl. CPC E06C 1/34; A01M 31/02

(57) ABSTRACT

Quick connect mounting system, tree hunting blinds, and ladders utilizing a base clamp in conjunction with a quick connect clamp at the upper most end of the assembly. The blinds, ladders and other equipment can be used with retractable safety harnesses that can be attached to the person at ground level prior to placing the blind or ladder in upright position.

This application claims priority front U.S. Provisional application having Ser. No. 61/948/632, filed Mar. 6, 2014.

This disclosure deals with a quick connect mounting system and tree hunting stands.

### BACKGROUND

There are a large number of methods by which tree hunting stands (blinds) are mounted to trees. Several examples of such systems can be found in the following U.S. Pat. No. 8,511,433 issued to Place on Aug. 20, 2013; U.S. Pat. No. 5,564,524, that issued to Thaggard at al on Oct. 15, 1996; U.S. Pat. No. 6,668,977, that issued to Arsenault on Dec. 30, 2003; U.S. Pat. No. 6,604,606, that issued to McDougal on Aug. 12, 2003; U.S. Pat. No. 8,230,972, that issued to Johnson on Jul. 31, 2012; U.S. Pat. No. 4,811,803 that issued to Green on Mar. 14, 1989; U.S. Pat. No. 8,407,934, that issued to Solares on Apr. 2, 2013; U.S. Pat. No. 3,918,849, that issued to Bliss on Jul. 6, 1999, and U.S. Pat. No. 5,275,257, that issued to Robertson on Jan. 4, 1994. None of these systems show or make obvious the novel mounting system of the instant DISCLOSURE.

### THE DISCLOSURE

Thus, what is disclosed in this specification is a quick mount hunting blind, wherein the quick mount hunting blind is comprised of a combination of base collar; one or more extendable struts rotatably attached to the base collar; at least one platform rotatably attached to each of the struts at an end opposite the base collar attachment, and wherein each platform is attached to a head of a clamp mount, the clamp mount being configured to embrace a vertical post and retain the platform against the vertical post.

For purposes of this invention, the quick mount is by a clamping mechanism. The preferred clamp mounts being a stag clamp or a grapple clamp.

In addition, this disclosure contemplates store than one platform on each mounting device and a swivel seat mounted on one or more of the platforms.

Also contemplated within the scope of this disclosure is a ladder wherein the ladder is also quick mounting.

In addition, there is a quick mount hunting blind, wherein the quick mount hunting blind comprises in combination a base collar; a fall arrest tower having a rotatable seat mounted to it, wherein the fall arrest tower is telescopic and has a mountable lower end and a mountable upper terminal end.

The fall arrest tower has attached to it a platform. The platform has a leading edge and a rear edge. There is a rotatably fixed ladder mounted on the leading edge and a first connector mounted on the rear edge. The connector is connected to a clamp mount wherein the clamp mount is configured to embrace a vertical post and retain the platform and fall arrest tower to the vertical post.

The fall arrest tower has a top collar located at the upper terminal end and there is a means for locking the clamp mount to the vertical post.

Another embodiment of this disclosure is a method of mounting a Blind. The method comprises mounting the base collar on a tree and mounting a tow collar on the tree above the base collar. The tow collar has a rotatable pulley mounted on it.

Thereafter, attaching a tow cord to the rear edge of the platform and threading the tow cord around the rotatable pulley and attaching the tow cord to a spool of a hand winch.

Thereafter, cranking the hand winch until the platform is adjacent the tree and attaching the upper terminal end of the fall arrest tower to the tree and locking the locking means attached to the platform.

In yet another embodiment, there is a method of mounting a blind, the method comprising mounting a base dollar on a tree. Also, there is a tow collar mounted on the tree, above the base collar, the tow collar having rotatable pulley mounted on it.

There is a tow cord attached to the rear edge of the platform which is threaded around the rotatable pulley and attached to a spool of a winch mounted on a motorized vehicle.

One then operates the winch until the platform is adjacent to the tree. Thereafter, the upper terminal end of the fall arrest tower is attached to the tree and the locking means is locked, that is attached to the platform.

In another embodiment, there is a method of mounting a blind, the method comprising mounting a base collar on a tree; mounting a tow collar on the tree above the base collar, wherein the tow collar has a rotatable pulley mounted on it.

Thereafter, attaching a tow cord to the rear edge of the platform and threading the tow cord around the rotatable pulley and attaching the tow cord to a motorized vehicle and moving the motorized vehicle until the platform is adjacent the tree.

Thereafter, attaching the upper terminal end of the fall arrest tower to the tree locking the locking means attached to the platform.

Still further, there is an embodiment which is a quick mount ladder, the quick mount ladder comprising in combination a ladder having a bottom end and a top end and a base collar securely attached to the bottom end. There is a lock rotatably mounted near the bottom end and extending and mounted to the ladder near the top end. The top end of the ladder is attached to a head of a clamp mount, the clamp mount configured to embrace a vertical post and retain the ladder against the vertical post. As indicated Supra, the ladder can be a stick ladder.

### BRIEF DESCRIPTION OF THE DRAWINGS

FIG. 1 is a side view of a portion of a vertical such as a tree, showing the base collar and the attachment of several struts.

FIG. 2 is a full top view of a stag clamp of this disclosure.

FIG. 3 is a full top view of a grapple clamp of this disclosure.

FIG. 4A is a full side view of a pivoting platform in motion as it advances upwardly towards a tree.

FIG. 4B is a full side view of two pivoting platforms in motion as they advance upwardly towards a tree.

FIG. 5 is a full top view of three platforms configured around a tree by the disclosure described herein.

FIG. 6 is a full side view of a ladder in motion as it advances upwardly towards a tree.

FIG. 7A is a full front view of the ladder of FIG. 6, in place against the tree.

FIG. 7B is a full side view of the ladder of FIG. 6 in place against the tree without the use of a base clamp.

FIG. 8 is a full side view of the quick mount hunting blind in place against the tree supported by the base collar, strut, and clamp.

FIG. 9 is a full side view of a blind of this invention.

FIG. 10 is an enlarged view of the top of the fall arrest tower showing a safety retainer affixed thereto.

FIG. 11 is a full side view ox a blind showing the fall arrest tower, swivel seat and retractable tether and Prusik Knot.

FIG. 12 is a full side view of the blind assembly of FIG. 11 wherein the fall arrest tower is extended.

FIG. 13A is a full side view of a blind of this disclosure showing the secondary swivel arrangement of the seat.

FIG. 13B is an enlarged view of the swivel seat and secondary swivel point assembly.

FIG. 14 is a full top view of the back of the swivel seat showing the locking positions of the seat.

FIG. 15 is a full side view of a stick ladder of this disclosure on a tree.

FIG. 16 is a side view of a blind mounting/raising using a mechanical hand winch.

FIG. 17 is a full side view of a blind mounting/raising using an ATV winch.

FIG. 18 is an illustration of a Prusik knot tied around a rod.

### DETAILED DESCRIPTION OF THIS DISCLOSURE

The assemblies of this disclosure address three significant unmet needs in the elevated deer blind market, namely, ease of use and mounting and dismounting, and hunter safety.

With regard to FIG. 4A, the assemblies 1 of this disclosure do this through the primary benefit of allowing hunters to mount a blind 2 from the ground thereby eliminating the need to climb a tree 3. This is accomplished through a folding blind design that pivots from a primary collar mechanism 4 and uses a quick connecting clamp 5 affixed to the rear 6 of a platform 7 of the blind assembly 1.

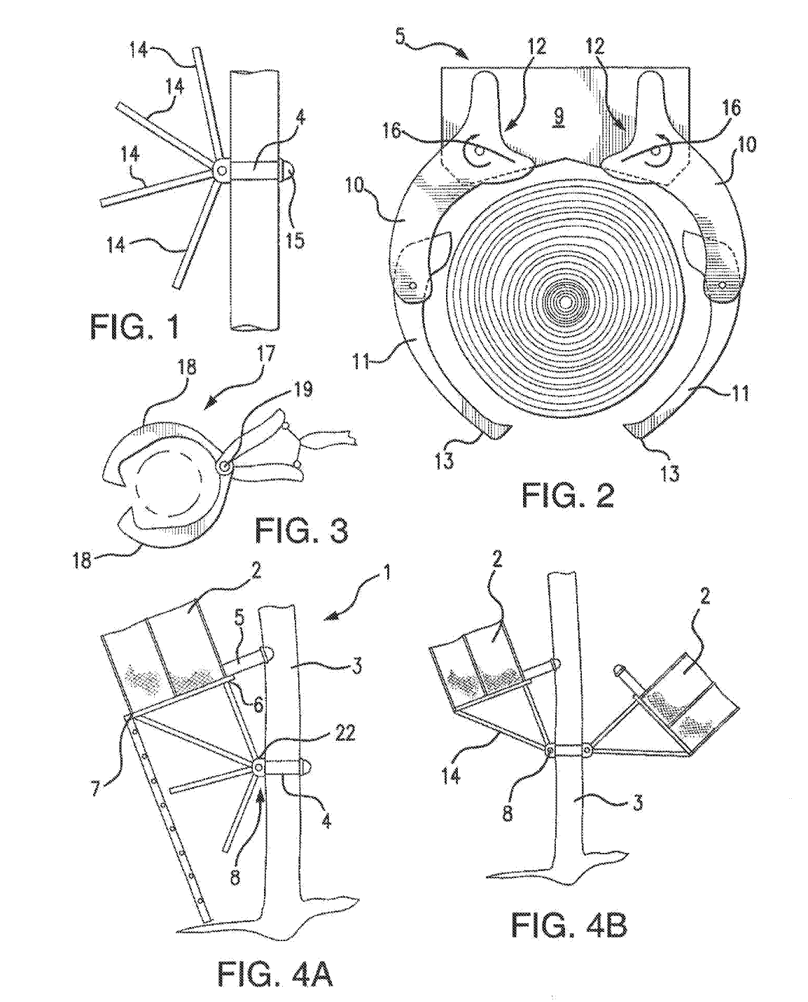

The assembly 1 uses a base collar 4 that is clamped around a vertical post 3 (See FIG. 1) using a connector 15. This feature allows for the initial connection to the tree 3 without the use of a ladder or climbing device. The base collar 4 is wrapped and secured at approximately shoulder height to the hunter and acts as the pivot point for the folding blind assembly 1. The base collar 3 creates a stable pivot point 8 by which the blind assembly 1 can be raised easily and without the need to climb the tree 3. This is achieved by providing struts 14 rotatable attachable to the base collar 4 at pivot point 8. The elimination of an elevated mounting process additionally allows for substantially larger blind platforms to be used. The aid of a pivot point 8 allows the hunter to swivel a substantial amount of weight upward.

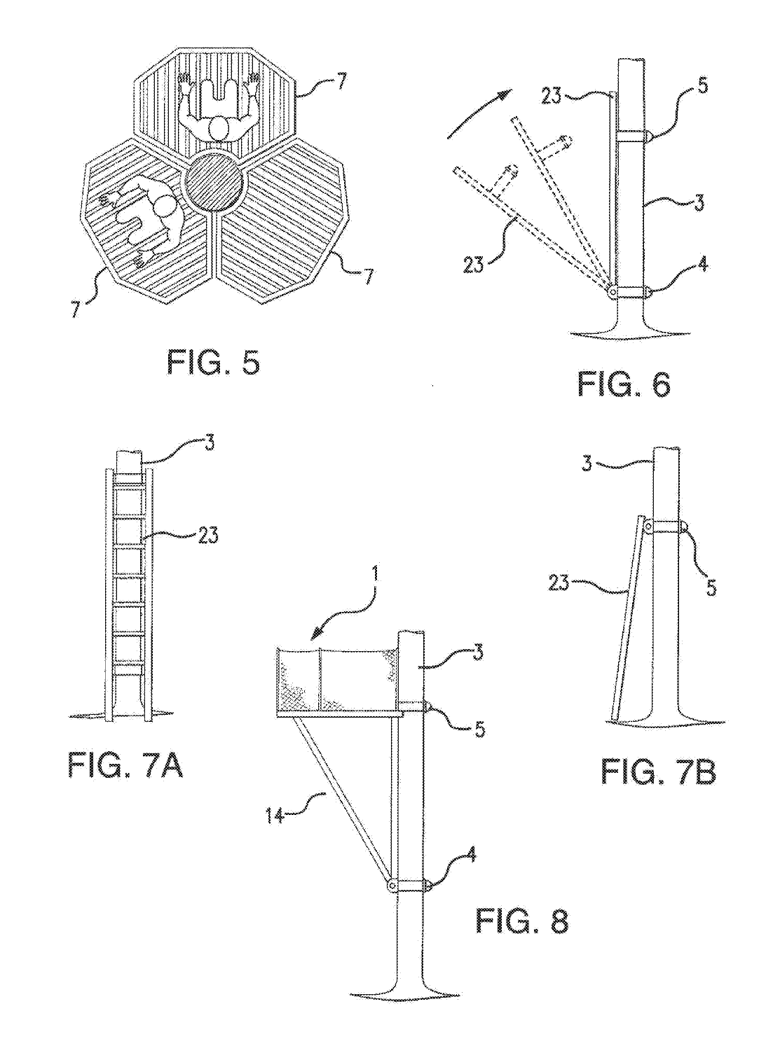

The primary collar mechanism 4 allows for the connection of additional platforms by multiple connection points (See FIG. 5). Once connected via the quick connection primary collar mechanism 4, the blind platforms 7 may be connected to each other allowing for an interconnected hunting surface. This potentially increases the blind assembly surface area to 360 degrees around the tree 3. Alternatively, differing styles of blind platforms 7 can be affixed to the primary collar mechanism 4 depending on the type of hunting being performed. As an example, a bow hunter may like a much smaller and lighter platform to help in the transportation of the blind.

One key element of this assembly 1 is to allow for connecting of the tree blind platform 7 without the need to wrap a strap or chain around the circumference of the tree 3. This allows for mounting and locking from the ground, increasing the safety of mounting elevated blinds. Contemplated within this disclosure is the use of safety straps and harness with the assemblies 1 of this disclosure.

The clamps 5 are the main mechanism that is used to affix the blind assembly 1 to the free 3. Two such clamps 5 are the stag claim, named after the stag beetle, which functions as a clamp that is uniquely shaped to grasp onto a vertical running cylinder of various radii, above the head, while resisting pulling away from the cylinder while under force.

The clamp 5 holds onto the cylindrical object 3 by way of a self-closing and self-locking ratchet and/or pulley and lever system. A back-up tightening mechanism maximizes holding power, providing an integrated device that provides fall protection rated for adult males.

Once the stag clamp, is fully secured to the vertical object, its strength is sufficient enough to provide long term support of optional platforms and adult males.

FIG. 2, wherein there is shown the head, 9, which is simply the main body to which the stag mandibles 10 are attached. This clamp 5 is then attached to a separately manufactured product such as a ladder to a tree blind. The base is capable of withstanding all forces rated for the entire device. A fall restraint may or may not be directly attached to the base. The mandibles, 10 consist of a finger 11 that is the largest main (hooked) part of the system. It is connected to the head plate 9 and is the primary holding component. It is directly connected to the locking and/or tightening mechanism 12. The finger 11 can act alone so long as it passes the widest section of the tree by about 70%. The tip 13 may or may not have a sharpened point for digging into support in objects, namely, wood.

Component 16 is the thumb which is integrated to the finger 11. The thumb 16 is the main lever used to increase tightening action. It may or may not be directly linked to the locking mechanism.

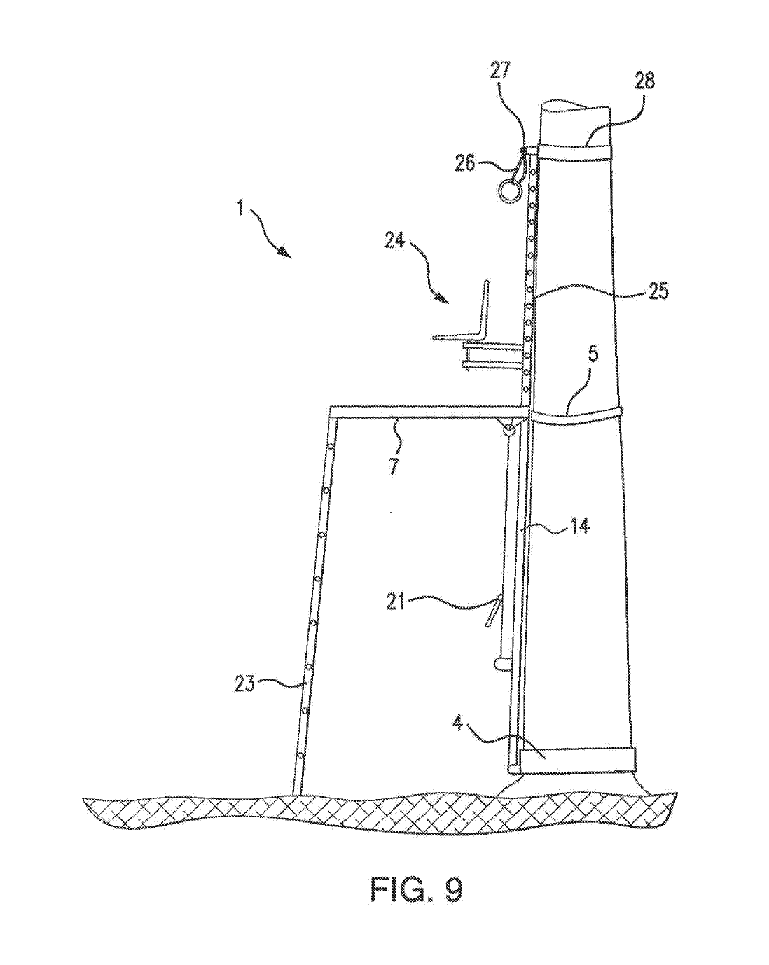

Component 11 is the tine and is optionable to the mandible. It is configured to work with various sized objects within a range of sizes. If sizes exceed a range, smaller or larger tines can accommodate these size differences. The principle of this component works as an over center cam action that creates leverage and thus holding power at an extended reach of the mandible to ensure grasp is at least 70% or more on the cylinder. The tine 11 may or may not have a sharpened point for digging into the support object. The locking mechanism 21 is shown in FIG. 9.

The grapple clamp 17 is sown in FIG. 3 and is another preferred clamp for use in this disclosure. The mechanism of actions is very similar to the stag clamp but with the closing force being attained by pulling distally, elongated legs 18 together, by means of a single pivot point 19 in a very similar way to scissors or ice tongs. The force being applied via a. ratchet and locking mechanism that is attached in a similar way to the stag clamp. Clamp configurations can vary depending on the size of the tree, blind configuration, and weight of the hunter.

One or more telescoping struts 14 are affixed to the base collar 4 and to the hunting platform 7 via a rotatable mounting 22. This rotatable mount allows the hunter to push the platform 7 to the desired height by pushing the bottom of any affixed ladder 23 (FIG. 4A). Alternatively, the hunter may elevate the blind by pushing on the struts 14 (See FIG. 6).

It is contemplated within the scope of this disclosure to affix a swivel heat 24 to the top of one or more of the platforms 7 being used.

Using the same principles as used in the elevated hunting blind, the ladder system may be connected via a primary collar and a quick connecting collar (See FIGS. 7A and 7B). FIG. 8 shows a full assembly 1 in location and attached to a tree 3.

FIG. 5 shows a top view of multiple platforms 7 being used with the assembly 1 of this disclosure.

Turning now to another embodiment of this invention, there is shown in FIG. 9 the use of assembly 1 with a fall arrest tower 25. The fall arrest tower 25 is telescopic in nature and can be shortened or extended depending on the nature of the blind or assembly 1 being used. It is important to note that this invention allows the combination of the fall arrest tower with ground mounting, allowing a hunter to connect to a safety line or retractable safety belt or a Prusik line, from the safety of the ground. Retractable safety belts useful in this invention can be found in U.S. Pat. No. 7,036,628.

As shown in FIG. 9, the fall arrest tower 25 is affixed rotatably to base clamp 4, and the platform 7 is affixed to the fall tower 25 and the terminal end of the fall tower 25 is clamped in place on the tree 3 by the clamp 5. Also shown attached to the fall tower 25 is a safety restraint mechanism 26, which can be a safety harness or a ratchet assembly. The restraint mechanism 26, for purposes of this invention is affixed to the fall tower 25 by a Prusik knot 27. In FIG. 9, there is also shown an additional tie band 28.

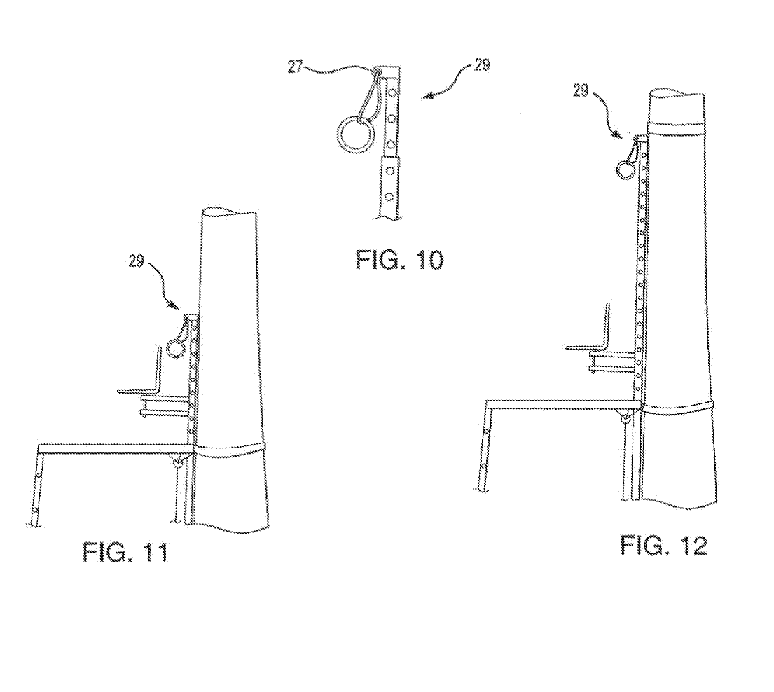

FIGS. 11 and 12 show the fall arrest tower 25 in a lowered position (FIG. 11) and a heightened position (FIG. 12). FIG. 10 shows the terminal end 29 of the fall arrest tower 25 enlarged, to shown the restraint mechanism 26 and the Prusik knot 27 in detail.

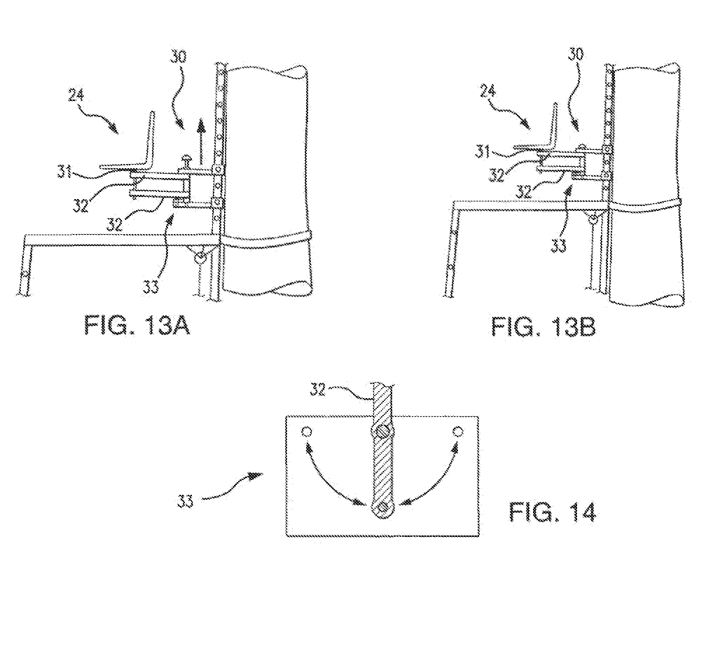

FIG. 13A shown the swivel seat 24 with the normal swivel point for the seat 31. FIGS. 13A and 13B show the swivel seat 24 in detail with a secondary swivel mechanism and control 30. The entire seat 24 and the support bars 32 are unlocked from the swivel lock mechanism 33 by raising them. Then, the secondary swivel mechanism 30 can be swiveled to the desired position and re-locked into position by dropping the entire mechanism into the lock mechanism 33. FIG. 14 shows a full top view of the control 30 and the positions.

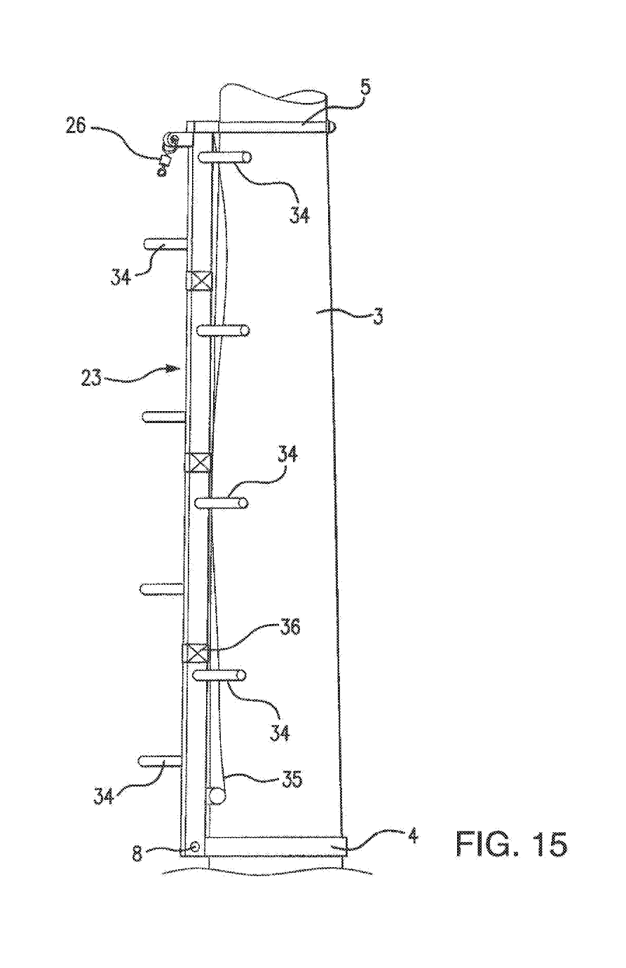

FIG. 15 is a full side view of a stick ladder 23 that has been attached to a tree 3 by the method of this invention, wherein there is shown the stick ladder 23, the tree 3, rungs 34 of the stick ladder, base clamp 4, pivot point 8, cock 35 for supporting the ladder during ascent and descent, clamp 5. It should be noted that the stick ladder 23 in this Figure is modular and shown is a module joint 36.

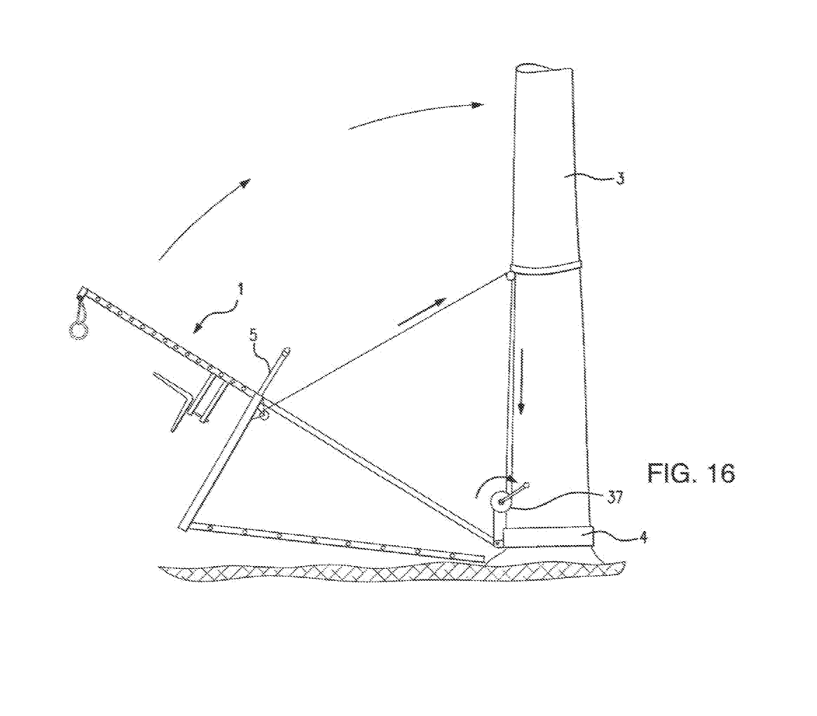

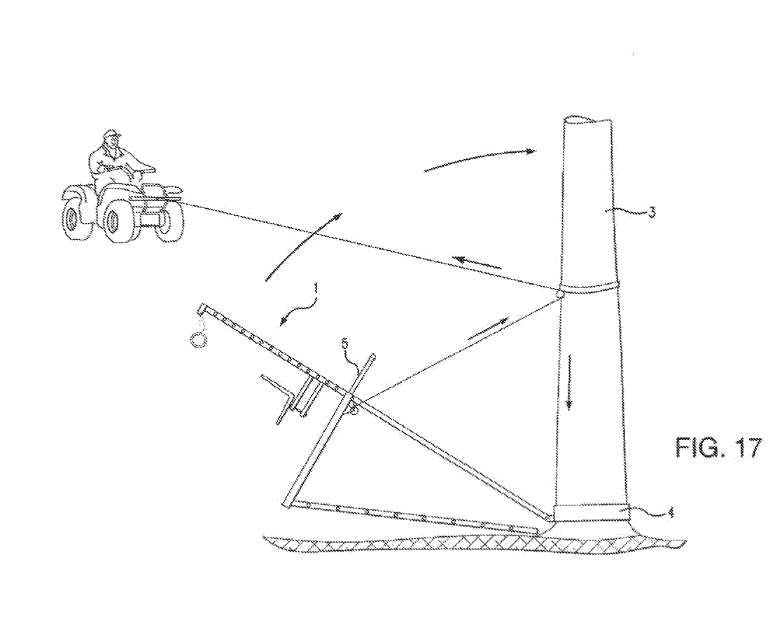

FIG. 16 shows the raising of an assembly 1 using a hand winch 37, wherein the hand winch 37 is fastened to the tree 3. FIG. 17 shows the raising of an assembly 1 using an ATV winch 38. It is also contemplated within the scope of this invention to attach the tow rope 39 to the ATV and pull the assembly 1 into position.

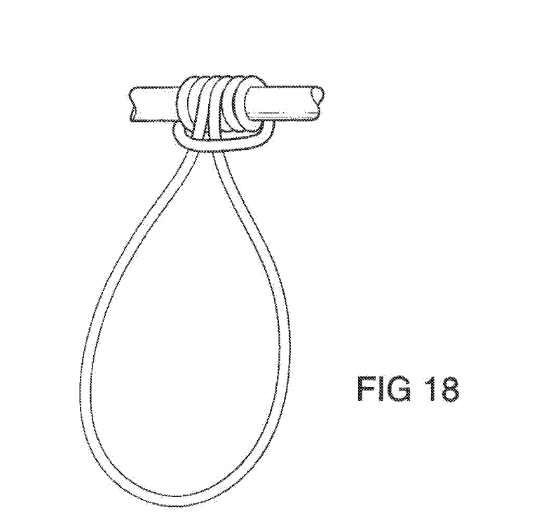

FIG. 18 shows a Prusik knot that is useful in this invention. It is shown tied around a rod, the rod not forming any part of this invention.

1. A quick mount hunting blind, said quick mount hunting blind comprising in combination:
a. a base collar;
b. one or more telescoping struts rotatably attached to said base collar;
c. at least one platform rotatably attached to each said strut at an end opposite said base collar;
d. each said platform being attached to a head of a clamp mount, said clamp mount configured to embrace a vertical post and retain said platform against said vertical post.

2. A quick mount hunting blind as claimed in claim 1 wherein said clamp mount is a stag clamp.

3. A quick mount hunting blind as claimed in claim 1 wherein said clamp mount is a grapple clamp.

4. A quick mount hunting blind as claimed in claim 1 wherein, in addition, there is mounted on each said platform a swivel seat.

5. A quick mount hunting blind as claimed in claim 1 wherein, there is present at least two platforms.

6. A quick mount hunting blind as claimed in claim 1, wherein, in addition, there is a ladder and said ladder is also quick mounting.

7. A quick mount hunting blind, said quick mount hunting blind comprising in combination:
i. a base collar;
ii. a fall arrest tower having a rotatable seat mounted thereto, said fall arrest tower being telescopic and having a mountable lower end and a mountable upper terminal end;
iii. said fall arrest tower having attached thereto, a platform, said platform having a leading edge and a rear edge, there being a rotatably fixed ladder mounted on said leading edge, there being a first connector mounted on said rear edge, said connector connecting to a clamp mount, said clamp mount being configured to embrace a vertical post and retain said platform and fall arrest tower to said vertical post;
iv. said fall arrest tower having a top collar located at said upper terminal end;
v. there being a means for locking said clamp mount to said vertical post.

8. A quick mount hunting blind as claimed in claim 7 wherein, in addition, there is a safety belt retractor coupled near to said upper terminal end of said fall arrest tower.

9. A quick mount hunting blind as claimed in claim 8 wherein, said safety belt retractor is coupled near to said upper terminal end of said fall arrest tower using a rope with a Prusik Knot.

10. A quick mount hunting blind as claimed in claim 7 wherein, in addition, said rotatable seat is adjustable along the length of said fall arrest tower.

11. A quick mount hunting blind as claimed in claim 7 wherein, in addition, said rotatable seat is equipped with a secondary swivel mechanism.

12. A quick mount hunting blind as claimed in claim 7 wherein, said ladder is a ladder stick.

13. A method of mounting a blind as claimed in claim 1, said method comprising:
i. mounting said base collar on a tree;
ii. mounting a tow collar on said tree, above said base collar, said tow collar having rotatable pulley mounted thereon;
iii. attaching a tow cord to said rear edge of said platform, threading said tow cord around said rotatable pulley and attach said tow cord to a spool of a hand winch;
iv. cranking said hand winch until said platform is adjacent said tree;
v. attaching said upper terminal end of said fall arrest tower to said tree;
vi. locking said locking means attached to said platform.

14. A method as claimed in claim 12 wherein said hand winch is attached to said tree.

15. A method as claimed in claim 12 wherein said hand winch is attached to said base collar.

16. A method as claimed in claim 12 wherein said hand winch is attached to a motorized vehicle.

17. A method of mounting a blind as claimed in claim 1, said method comprising:
i. mounting said base collar on a tree;
ii. mounting a tow collar on said tree, above said base collar, said tow collar having rotatable pulley mounted thereon;
iii. attaching a tow cord to said rear edge of said platform, threading said tow cord around said rotatable pulley and attach said tow cord, to a spool of a winch mounted on a motorized vehicle;
iv. operating said winch until said platform is adjacent, said tree;
v. attaching said upper terminal end of said, fall arrest tower to said tree;
vi. locking said locking means attached to said platform.

18. A method of mounting a blind as claimed in claim 1, said method comprising:
i. mounting said base collar on a tree;
ii. mounting a tow collar on said tree, above said base collar, said tow collar having rotatable pulley mounted thereon;
iii. attaching a tow cord to said rear edge of said platform, threading said tow cord around said rotatable pulley and attach said tow cord to a motorized vehicle;
iv. moving said motorized vehicle until said platform is adjacent said tree;
v. attaching said upper terminal end of said fall arrest tower to said tree;
vi. locking said locking means attached to said platform.

19. A quick mount ladder, said quick mount ladder comprising in combination:
i. a ladder having a bottom end and a top; end;
ii. a base collar securely attached to said bottom end;
iii. a lock rotatably mounted near said bottom end and extending and mounted to said ladder near the top end;
iv. said top end of said ladder being attached to a head of a clamp mount, said clamp mount configured to embrace a vertical post and retain said ladder against said vertical post.

20. A quick mount ladder as claimed in claim 17 wherein the ladder is a stick ladder.

21. A quick mount ladder as claimed in claim 20 wherein a safety belt retractor is coupled near to an upper terminal end of said ladder using a rope with a Prusik Knot.
